(19) United States
(12) Patent Application Publication
(10) Pub. No.: US 2016/0307282 A1
(43) Pub. Date: Oct. 20, 2016

(54) SYSTEM AND METHOD FOR AIDING NEIGHBORHOOD SELECTION

(71) Applicant: Dirk Darin James Inc., Calgary (CA)

(72) Inventor: Craig Stewart, Calgary, Alberta (CA)

(21) Appl. No.: 15/130,600

(22) Filed: Apr. 15, 2016

(30) Foreign Application Priority Data
Apr. 15, 2015 (CA) 2888080

(51) Int. Cl. G06Q 50/16; G06F 17/30; G06Q 30/06

(52) U.S. Cl. CPC G06Q 50/16; G06Q 30/0627; G06F 17/30867

(57) ABSTRACT

Determining a location to consider when purchasing property may be difficult. A system for selecting one or more potentially appropriate neighborhoods for a user may generate profiles of different neighborhoods within a city. A generated user profile may be matched to the neighborhood profiles in order to provide potentially appropriate neighborhoods to a user.

### CROSS-REFERENCE TO RELATED APPLICATIONS

This application claims priority under the Paris Convention to Canadian Patent Application No. 2,888,080 filed Apr. 15, 2015, which is incorporated herein by reference in its entirety.

### STATEMENT RE: FEDERALLY SPONSORED RESEARCH/DEVELOPMENT

Not Applicable

### BACKGROUND

The current disclosure relates to providing information for purchasing a property, and in particular to determining possibly appropriate neighborhoods for a purchaser.

Balancing different requirements, such as proximity to work, schools in the area, local amenities and price when selecting a home or property to purchase or rent can be difficult. Working with a knowledgeable realtor may make the process more manageable; however it can still be daunting. Numerous online tools are available to help a purchaser in making their decision. These tools may provide various useful information to a purchaser including, for example demographic information of an area a particular home or property is located in etc.

Although various online tools are available for aiding in making a decision regarding the purchase of a particular home or property, it may still be difficult to select areas or neighborhoods to focus on in the search for potential properties without specific knowledge of the area.

An additional, alternative and/or improved tool for use in selecting a home or property is desirable.

### BRIEF SUMMARY

In accordance with the present disclosure there is provided a method for identifying an appropriate neighborhood for a user comprising: receiving answers to a plurality of profiling questions at a computing system; generating at the computing system a user profile of the user based on the received answers to the plurality of profiling questions; comparing at the computing system the user profile to a plurality of neighborhood profiles, each generated according to classification information of a respective physical neighborhood associated with the respective neighborhood profile; and identifying at the computing system at least one of the plurality of neighborhood profiles as appropriate for the user based on results of the comparison between the user profile and neighborhood profiles.

In accordance with the present disclosure there is further provided a system for identifying an appropriate neighborhood for a user comprising: a processing unit for executing instructions; and a memory unit for storing instructions which when executed by the processing unit configure the system to: receive answers to a plurality of profiling questions at a computing system; generate at the computing system a user profile of the user based on the received answers to the plurality of profiling questions; compare at the computing system the user profile to a plurality of neighborhood profiles, each generated according to demographic information of a respective physical neighborhood associated with the respective neighborhood profile; and identify at the computing system at least one of the plurality of neighborhood profiles as appropriate for the user based on results of the comparison between the user profile and neighborhood profiles.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a system for selecting potential neighborhoods for a user;

FIG. 2 depicts components for selecting potential neighborhoods for a user;

FIG. 3 depicts processes for selecting potential neighborhoods for a user;

FIG. 4 depicts a process for profiling a neighborhood;

FIG. 5 is a schematic of user and neighborhood profiles;

FIG. 6 depicts a process for selecting potential neighborhoods for a user profile;

FIG. 7 depicts a further process for selecting potential neighborhoods for a user profile;

FIG. 8 depicts a further process for selecting potential neighborhoods for a user;

and

FIGS. 9-11 depict user interfaces for selecting potential neighborhoods for a user.

### DETAILED DESCRIPTION

Searching for a neighborhood to move to can be difficult, especially if the person is not from, or familiar with, the city they plan to move to. A system for determining possible neighborhoods that may be desirable for a user to live in may simplify the home searching process. Neighborhoods may have one or more characteristics that make them more desirable to certain individuals. For example, a neighborhood may have a relatively high number of bars and restaurants that make the neighborhood generally more desirable for younger individuals, while a neighborhood with more parks may be generally more desirable for families. Generating neighborhood profiles and then matching those profiles to profiles of individuals looking for a home or property allows one or more potentially appropriate, or desirable, neighborhoods for the individual to be identified. The neighborhood identification process may be used to identify suitable neighborhoods to look for homes or properties within. By identifying neighborhoods for individuals, the amount of specific knowledge of an area required by an individual in order to make an informed decision may be reduced.

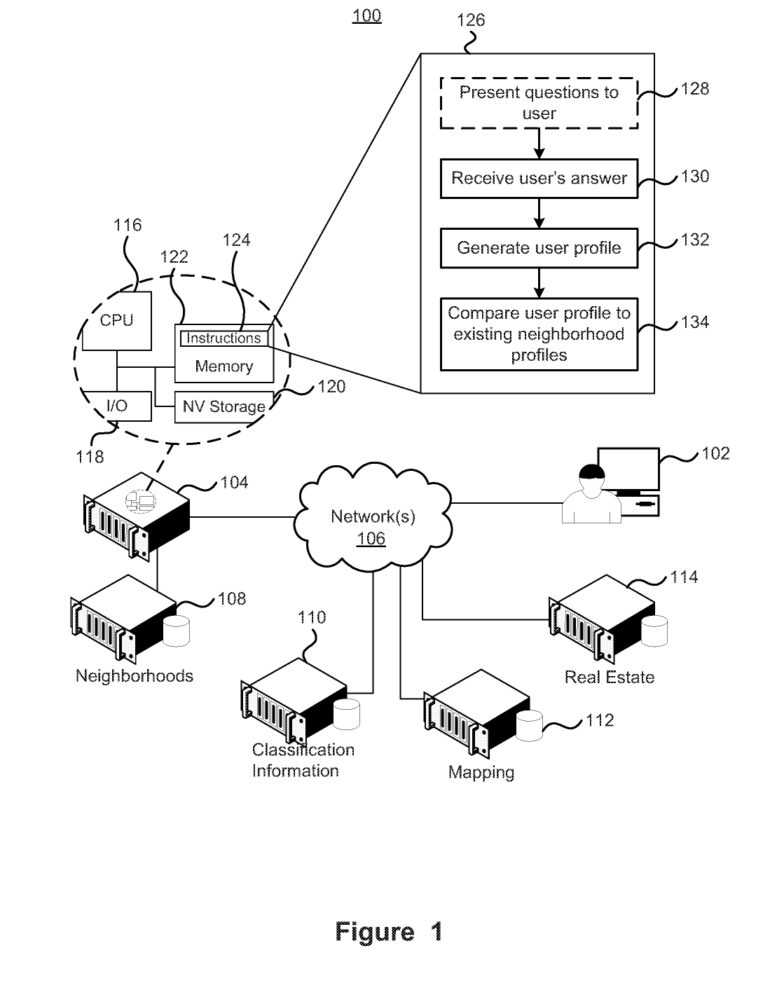

FIG. 1 depicts a system for selecting potential neighborhoods for a user. It is assumed that a user is interested in purchasing a home or property. The system 100 determines one or more neighborhoods that might be appropriate for the user to search for homes in. The system 100 comprises a number of interacting components of hardware and software. It will be appreciated that the components depicted in FIG. 1 are intended to convey components specific to determining potential neighborhoods and may omit other components. For example, networking elements required to provide communication between depicted components have been either omitted or generalized in FIG. 1. Further, the components depicted in FIG. 1 are intended to provide a basis for describing how to provide neighborhood suggestions to the user. The depicted components are not intended to be limiting. For example, it will be appreciated that computer system 102 of the user is depicted as a desktop computer; however, the same or similar functionality could be provided by other computing devices, including laptop computers, tablet computing devices, phones, or other computing devices that allow the user to interact with other computing devices. Similarly, one or more of individual computing systems 104, 108, 110, 112, 114 may be provided by a plurality of cooperating computing systems providing distributed computing systems, and/or as a plurality of separate computing systems providing the same or similar functionality.

A user computing device 102 communicates with a neighborhood selection computing device 104 that provides functionality for selecting one or more neighborhoods for the user. Both the user's computing device 102 and the neighborhood selection computing device 104 are connected to one or more networks 106 that allow communication between the computing devices 102, 104 as well as other computing devices. The other computing device may provide various information to the neighborhood selection computing device 104. For example, a neighborhoods computing device 108 may provide information describing neighborhoods within one or more cities. A classification information computing device 110 may provide classification information for neighborhoods, areas, cities and/or regions. A mapping computing device 112 may provide mapping information, such as street names and locations, information on bodies of water, etc. that may be used in providing a visual map of a neighborhood, area, city and/or region. Although depicted as a single computing device, it is possible that the classification information is provided by a plurality of different computing devices. A real-estate computing device 114 may provide real estate information for different neighborhoods, areas, cities and/or regions, including for example homes or properties for sale. Although depicted as separate computing devices, the information and/or functionality provided by one or more of the computing devices 104, 108, 110, 112, 114 may be combined together and provided by a common computing device. The information provided by the computing devices 108, 110, 112, 114 may be provided by the same entity that provides the neighborhood selection functionality or may be provided by one or more third party entities. For example, third party entities may provide the neighborhood selection computing device access to neighborhood information, classification information, mapping information and real estate information. Additionally or alternatively, the information may be provided by the same entity that provides the neighborhood selection computing device.

The neighborhood selection computing device 104 provides functionality for selecting a neighborhood that may be appropriate for the user. An appropriate neighborhood may be considered to be a neighborhood that the user would likely consider to live in. The neighborhood selection computing device 104 may comprise a processing unit 116 for executing instructions for configuring the computing device 104. The processing unit 113 may comprise one or more processing cores coupled together. The processing cores may be located on the same physical component or one separate physical components that are communicatively coupled with each other by internal or external connections. The computing device 104 may further comprise one or more input/output (I/O) interfaces 118 coupled to the processing unit 116 either directly or indirectly. The I/O interfaces may allow other components to be connected to the computing device and may include for example, display devices, pointing devices, keyboards, speakers, microphones, network interfaces, and other devices. The computing device 104 may further include non-volatile store 120, which may be provided by for example, hard disk drives, solid state drives, flash drives, optical disc drives and other types of devices that can store data, including instructions, through periods without power. The computing device 104 further comprises memory 122 that stores instructions 124 and data for execution by the processing unit 116. When executed by the processing unit 116, the instructions 124 configure the computing device 104 to provide neighborhood selection functionality 126.

The selection functionality 126 presents a user with a plurality of questions (128). The questions may be presented to the user through a web site that allows the user to submit answers to the neighborhood selection computing device 104. The questions presented to the user are selected in order to allow a profile of the user to be generated. The user's answers are received (130) by the neighborhood selection computing device 104 and are used to generate a user profile (132). The generated user profile classifies characteristics of the user that may be useful in determining one or more appropriate neighborhoods for the user. For example, the user profile may characterize a user's education level, ethnic background, income, interests, age, sex, marital status etc. The generated user profile is compared to existing profiles of neighborhoods (134). The comparison of the user profile to the neighborhood profiles can identify one or more neighborhoods that match the user profile, and as such may be considered as a potentially appropriate neighborhood. Once one or more appropriate neighborhoods are determined for a user, the identified neighborhoods may be used in various ways including presenting the neighborhoods to the user, determining houses or properties for sale in the neighborhood, presenting a real-estate agent associated with the identified neighborhood, providing user information to a real-estate agent associated with the neighborhood, etc. It is contemplated that the neighborhood selection computer device 104 provides a user interface to the user, or more particularly the user's computing device 102, by way of a web site. However, it will be appreciated that the presented user interface may be provided outside of a web browser. For example, the user interface and/or one or more components of the neighborhood selection functionality may be provided as a desktop application, an app on a phone or other types of user interfaces that are capable of displaying the information generated by the neighborhood selection computing device 104.

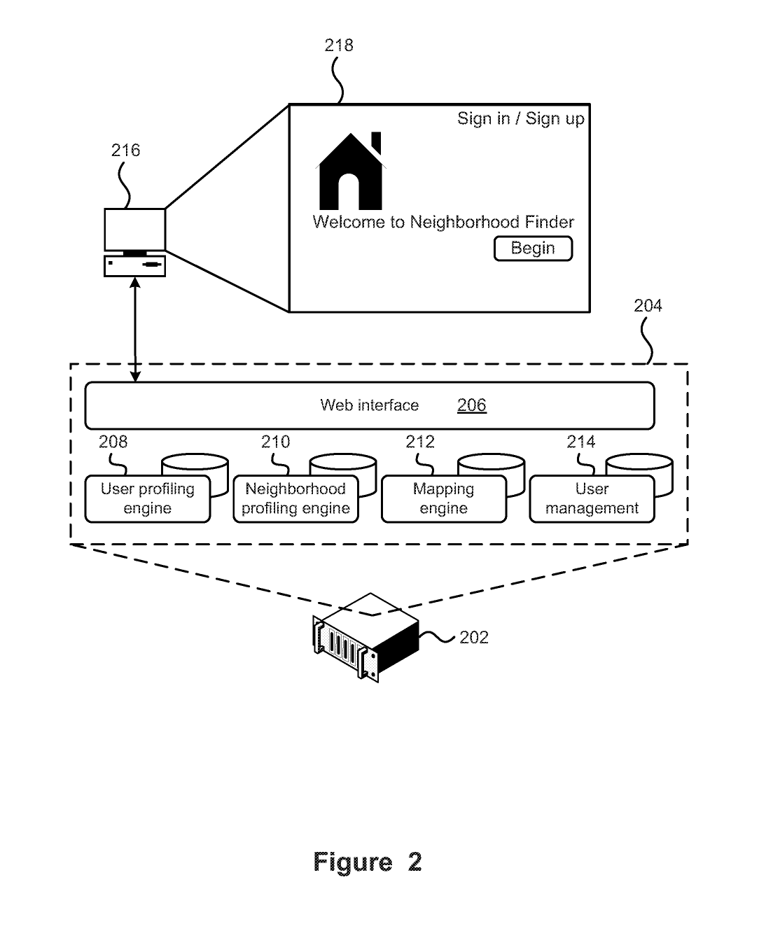

FIG. 2 depicts components for selecting potential neighborhoods for a user. As depicted in FIG. 2, functionality 204 may be provided by a computing device 202, which may be for example computing device 104. The functionality 204 provides an user interface for interacting with the functionality 204 that can determine an appropriate neighborhood for a user. The functionality 204 may include web interface functionality 206 that generates and provides a web based interface. The web interface 206 may be provided by a web server that responds to a user's request for a web page. The web interface 206 may generate a web page for a user by incorporating information and/or functionality from other components providing functionality. The functionality that may be utilized by the web interface may include a user profiling engine 208 that generates a user profile based on a user's response to questions. The user profiling engine 208 may provide the generated user profile back to the web interface for use in comparing to existing neighborhood profiles. Additionally or alternatively, the user profiling engine 208 may generate the user profile and compare the user profile to existing neighborhood profiles and return matching neighborhood profiles to the web interface.

The functionality 204 may further include neighborhood profiling engine functionality 210 that generates profiles of neighborhoods. The neighborhood profiling engine may generate the neighborhood profiles and store the generated profiles for subsequent comparison to the generated user profiles. The neighborhood profiling engine 210 functionality may generate the neighborhood profiles during a configuration stage, or may generate or update profiles periodically when new information used in generating neighborhood profiles is available. The information used to generate a neighborhood profile may include classification information, for example provided by census data, of those living in the neighborhood, consumer information, questionnaires and/or surveys of individuals living in the neighborhood as well as other information on the neighborhood such as amenities in the neighborhood including, schools, hospitals, parks, business etc. The classification information may include demographic information, information on different preferences of a user, lifestyle information as well as other information that may be used in generating a profile of a user. The neighborhood profiling engine functionality 210 may be accessed by authorized users, such as an administrator, through the web interface 206 or through other interfaces.

The functionality 204 may further include mapping engine functionality 212 that generates a map image for incorporation into a web page generated by the web interface. The mapping engine functionality 212 may generate different views of an area. The mapping engine functionality 212 may generate a view based on differing layers of information including for example, overlays of neighborhood locations, road information, information on bodies of water, amenity locations, etc. The mapping engine functionality 212 may generate an image, or other component such as a section of HTML code, that can be incorporated into a web page by the web interface 206.

The functionality 204 may further include user management functionality 214. The user management functionality 214 may store user information, including for example usernames and passwords as well as associated user profiles and selected neighborhoods. The user management functionality 214 allows a user to periodically utilize the neighborhood selection functionality without having to redo previously completed steps. The user management functionality 214 may allow users to sign up and sign in to the web site providing the neighborhood selection functionality.

As depicted in FIG. 2, a computing device 216, which may be for example a user's computing device 102, may be used to access the user interface generated by the web interface 206. As depicted, the user interface may be presented as a website 218 that provides access to the neighborhood selection functionality. Although depicted as a web based application, the same or similar functionality may be provided in other forms, such as standalone desktop applications and/or apps for computing devices such as smart phones or tablets.

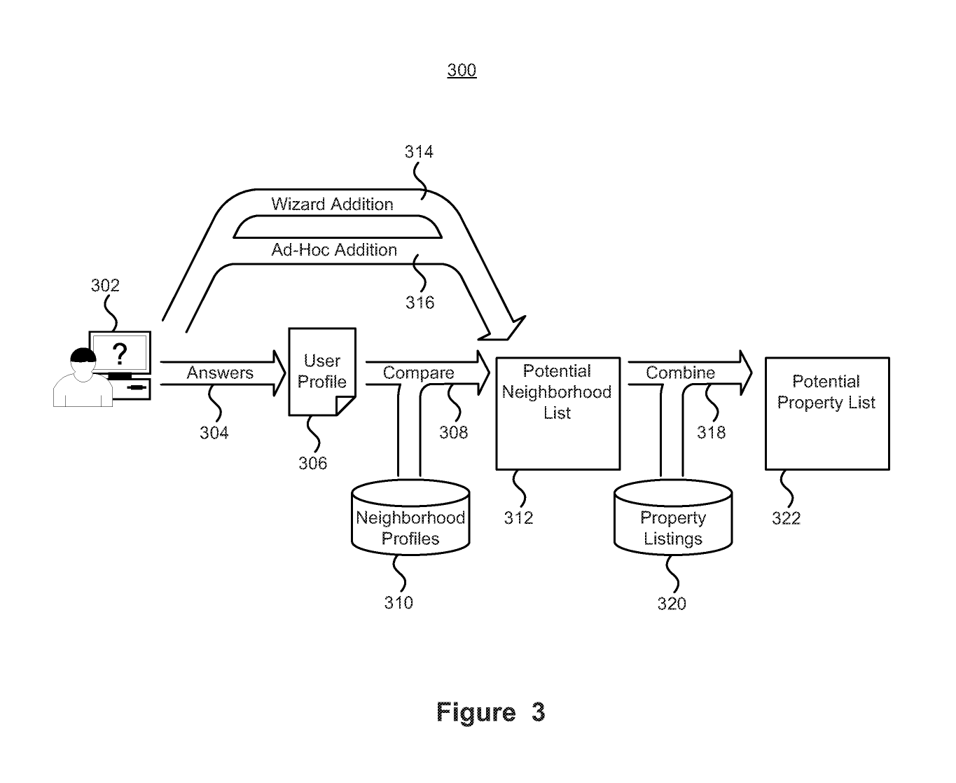

FIG. 3 depicts processes for selecting potential neighborhoods for a user. The process may begin with presenting the user with a plurality of questions to answer 302. The answers to the questions are processed, depicted by arrow 304, and used to generate a user profile 306. The generated user profile 306 may be compared, depicted by arrow 308, to existing profiles of neighborhoods 310. The neighborhood profiles 310 may have been previously generated for the neighborhoods, for example by neighborhood profiling functionality described above. The comparison of the user profile 306, or a component of the user profile 306, to neighborhood profiles 310 may match the user profile with one or more neighborhood profiles of neighborhoods that may be considered as appropriate for a user. The potentially appropriate neighborhood may be added to a potential list of appropriate neighborhoods 312. The list of neighborhoods may be ordered based on how appropriate a neighborhood may be for a particular user. The appropriateness of a neighborhood may be based on various factors that may be used as a weighting for ordering the list. Factors may be either explicitly provided by the user, for example a user may explicitly indicate a preference for one neighborhood over another, or may be implicit, for example if a user spends a substantially longer time reviewing information of one neighborhood versus another, it may indicate a preference for that neighborhood. Further the list of neighborhoods may be filtered or ordered based on information in the user profile.

The list of potential neighborhoods based on the profile matching may be added to or refined based on other factors. For example, a user may add specific neighborhoods to the potential neighborhood list in an ad-hoc manner 316 by explicitly selecting the particular neighborhoods, for example from a list of neighborhoods or a map of neighborhoods. Additionally, the list of potential neighborhoods may be refined, or added to, based on one or more wizards 314 or other user input. For example, a commute wizard may be used by a user to indicate an importance of a commute length to a job location. For example, if the list has two neighborhoods that are otherwise equally appropriate to the user but one has a significantly shorter commute which the user has indicated as being important through the commute wizard, the list may be order to indicate that the closer neighborhood may be more appropriate. Similar information could be determined from the user profile. For example if a user's profile indicates that they do not have an automobile, it may be assumed that walkability of the neighborhood, or access to public transportation is important to the user. The list of potential neighborhoods may be ordered or filtered based on one or more wizards, or additional neighborhoods may be added. The neighborhood list 312 may be presented to the user or used by other systems that utilize neighborhood information.

The potential neighborhood list may be combined, depicted as arrow 318, with property listings 320. The property listings 320 may present currently available properties for sale. The property listings include a location or address of the respective property which may be correlated to the location of neighborhoods. Accordingly, the listed properties for the neighborhoods in the potential neighborhood list may be added to a potential property list 322. The properties on the potential properties list 322 may be presented to the user or used by other systems that utilize property information. For example, the user information and preferences, including contact information, could be provided to real-estate agents of the properties or registered as agents for the associated neighborhoods. The user information and preferences could be provided to agents as a qualified lead report. One or more agents may be associated with a neighborhood in order to receive associated reports. The potential property list 322 may be further refined or filtered. For example, the properties on the list may be filtered to only include those properties that match a user's specific property requirements such as price, property style, number of bedrooms etc.

In addition to the user interface described above, it is possible to provide additional or alternative interfaces, or interface components, to select users. For example, an advanced version of the interface with additional wizards and more detailed or personal information may be provided for use by real-estate agents and their clients such sensitive information including health information.

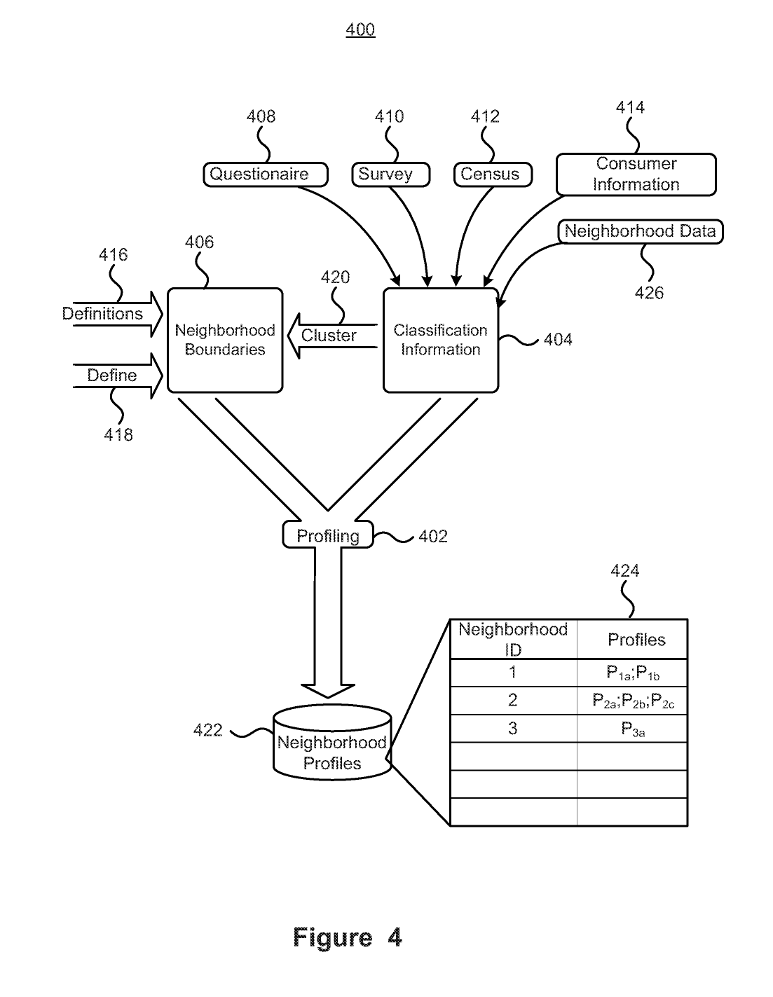

FIG. 4 depicts a process for profiling a neighborhood. The process 400 generates neighborhood profiles 422 based on various information. The information may provide by a number of different sources. The profiling process 402 can generate a neighborhood profiles 424 based on classification information 404 and neighborhood boundaries 406. The neighborhood boundaries specify the location of the particular neighborhoods and can be combined with the classification information to generate the profile for each of the neighborhoods.

The classification information 404 may be generated or received from various sources of demographic and lifestyle information on individuals living within the neighborhood boundaries. The sources may include questionnaires 408 such as telephone questionnaires, or polls, surveys 410 that may be completed by individuals, census information 412 provided by a government agency or other census information, as well as available consumer information 414 that may be available from 3^{rd} parties that track consumer habits. Additional information may be provided through the use of the neighborhood selection system itself, which may provide feedback information about the types of people interested in different types of neighborhoods. The various sources of information may be combined together to provide the classification information. The classification information may include demographic information about individuals living in the area. Additional neighborhood data 426 may also form part of the classification information used in profiling a neighborhood. The neighborhood data 426 may specify for example amenities of the neighborhood such as the presence of parks, hospitals, schools, businesses, bars, restaurants, entertainment venues etc, geographic information such as information on water frontage, forested, ravines etc. and recreational information paths, parks, hiking/biking trails etc. The profiling 402 of the neighborhoods, which may utilize both the demographic information 404 and neighborhood data 426, may store the generated profiles in a neighborhood profile database or similar structure 422.

The neighborhood boundaries 406 may be provided in various ways. For example, a town, city or real-estate organization may explicitly define neighborhood boundaries. These existing neighborhood definitions 416 may be used as the neighborhood boundaries. Additionally or alternatively, the neighborhood boundaries may be defined by a system user. For example, an administrator of the system may input coordinates defining 418 neighborhood boundaries. The coordinates may be input for example on a map that allows the neighborhood boundaries to be drawn. Further, the neighborhood boundaries may be defined, or further refined, based on the demographic information. For example, a neighborhood may be further subdivided into regions of homogenous, or largely homogenous, demographic information. The neighborhoods may be subdivided by clustering 420 demographic information together to identify homogenous regions within the neighborhoods. Regardless of how the neighborhoods are defined, a neighborhood may be considered as a specific geographic area for which there is demographic information available. Generally the neighborhood boundaries are semi-permanent, meaning they may change slowly overtime. As an example, one large neighborhood may see an influx of residents over a number of years and the neighborhood may eventually be segregated into two distinct neighborhoods.

The neighborhood database 422 may associate profiles with a neighborhood or neighborhood identifier. The associations between profiles and neighborhood IDs may be stored in a table 424 or similar structure. As depicted one or more profiles may be associated with an individual neighborhood. Although depicted as multiple profiles, a neighborhood may be associated with a single profile that incorporates multiple profile components.

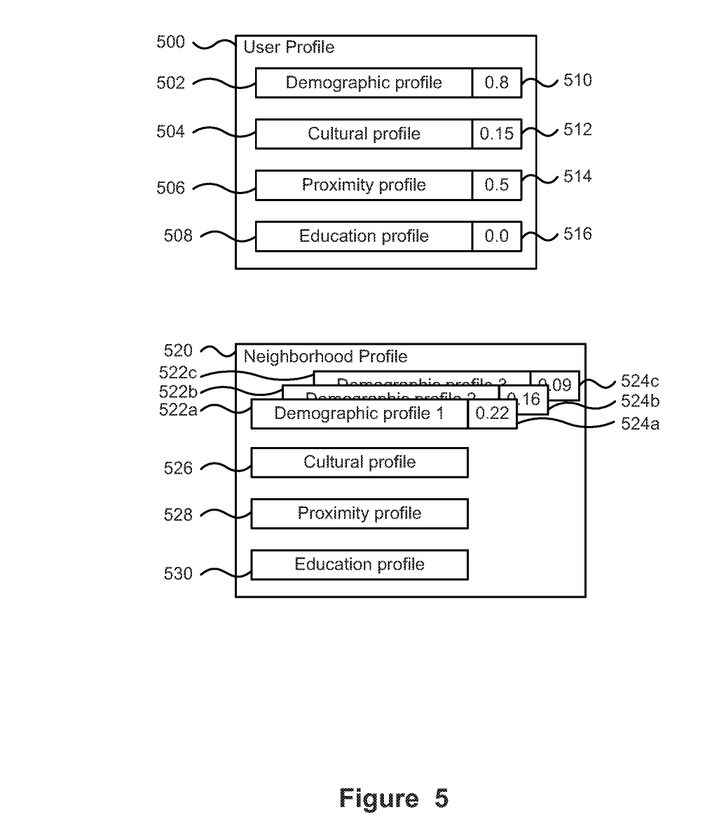

FIG. 5 is a schematic of user and neighborhood profiles. Each of the profiles 500, 520 may include various portions for classifying a user or neighborhood. The portions may include, for example a demographic portion, a cultural profile portion, a proximity profile portion and an education profile portion. Other types of profile portions, or sub-profiles, may include additional information on lifestyles of individuals, geographic features or characteristics of a neighborhood, such as waterfront, mountainous, etc. Further, the portions depicted in FIG. 5 may be combined into fewer portions, and/or separated into additional portions. The user profile 500 and the neighborhood profile 520 are similar in regard to the portions of the profiles in order to allow a comparison and matching between user profiles and neighborhood profiles.

The user profile 500 is depicted as comprising a plurality of profile portions that are based on a user's answer to questions presented to the user as well as additional sources of classification information. The answers to the questions may be used to classify the user into one of a plurality of predefined groups, categories or classifications.

As depicted, the user profile may include a demographic profile portions that indicates or represents demographic information such as age, sex, marital status, income, etc. The user profile may also include a cultural profile portion 504 that indicates cultural preferences of the user. A proximity profile portion 506 may define or describe a user's desires of proximity to various amenities. An education profile portion 508 may define a user's desire for available educational resources. In addition to the various profile portions 502, 504, 506, 508 that provide an indication of a user's preferences, each profile portion may be associated with a value indicative of the importance of each of the profile portions to the user in deciding a home. As depicted in FIG. 5, the demographic profile portion 502 may be the most important profile portion in deciding on a home or neighborhood with a normalized value 510 of 0.8. The user profile 500 indicates that the cultural profile portion of the neighborhood is less important to the user with a normalized value of 0.15. The proximity portion 506 of the user profile 500 is less important to the user and is associated with a normalized value 514 of 0.5. Finally, the user profile 500 indicates the education profile portion 508 is not important at all to the user and is associated with a normalized value 516 of 0. Different values may be assigned to the different profile portions.

A neighborhood profile 520 is similar to a user profile 500; however, the individual profile portions may not be associated with a value indicative of the importance of the profile portion as may be the case for user profiles 500. As depicted, the neighborhood profile 520 comprises corresponding profile portions as described above for the user profile 500. In particular, the neighborhood profile may include a demographic profile portion 522a, 522b, 522c, a cultural profile portion 526, a proximity profile portion 528, and an education profile portion 530. Other portions are possible such as a lifestyle profile portion, a geographic profile portion as well as other types of information on characteristics, preferences and/or desires.

As described above with reference to FIG. 4, a neighborhood may be associated with a plurality of neighborhood profiles. Although depicted as a plurality of profiles, a neighborhood may be associated with a single profile that comprises a plurality of demographic profile portions 522a, 522b, 522c. Each of the plurality of demographic profile portions 522a, 522b, 522c may be associated with a value indicative of a relative proportion of the associated demographic profile in the neighborhood. For example, as depicted, a first demographic profile 522a is associated with 22% 524a of the population of the neighborhood, while a second demographic profile 522b is associated with 16% 524b of the population of the neighborhood, while a third demographic profile 522c is associated with 9% 524c of the population of the neighborhood.

The profile portions of the user and neighborhood profiles may be provided in various manners. For example, the demographic profile portion, or other profile portions, may simply specify one of a plurality of predefined demographic categories. Additionally or alternatively, a profile portion may be provided as a fingerprint comprising a vector of values associated with particular demographic characteristics arranged in a predefined order. For example, a demographic profile vector could be based on three characteristics, namely an education level, an income amount and an age. The demographic profile may then be represented as a three element vector with values associated with each of the characteristics. Comparisons between user and neighborhood profiles may then be done based on vector calculations, for example, determining a neighborhood profile vector that is closest to a user profile vector. If vectors are used as profiles, the weightings of the values of the vector elements may be adjusted based on an importance of the particular characteristic to the user.

The user profiles and neighborhood profiles may be compared to each other in order to find neighborhoods that match the user's profile. The comparison process between a user profile and neighborhood profiles may depend upon how the profiles are defined.

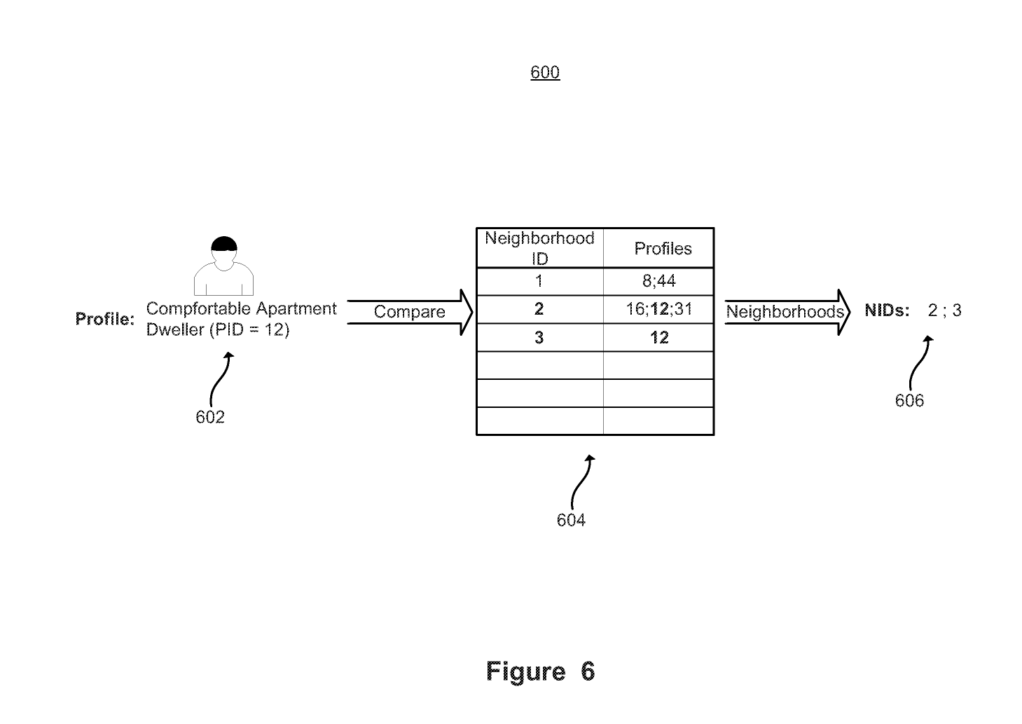

FIG. 6 depicts a process for selecting potential neighborhoods for a user profile. The process 600 assumes that the profiles comprise a demographic portion indicating a demographic profile identifier from a plurality of predefined profile identifiers. As depicted in FIG. 6, the user profile 602 may indicate a profile ID (PID=12) that is associated with a user classification from among a plurality of defined classification groups such as “comfortable apartment dweller.” The comparison process compares the user classification group ID to one or more classification group IDs associated with neighborhoods in a neighborhood profile table 604. As depicted, each neighborhood may be associated with one or more classification group IDs. The comparison process compares the classification group ID of the user profile to the individual classification IDs associated with the neighborhoods and when a match is determined, depicted by the bold classification group IDs, the corresponding neighborhoods may be added to potential neighborhoods that are appropriate for the user.

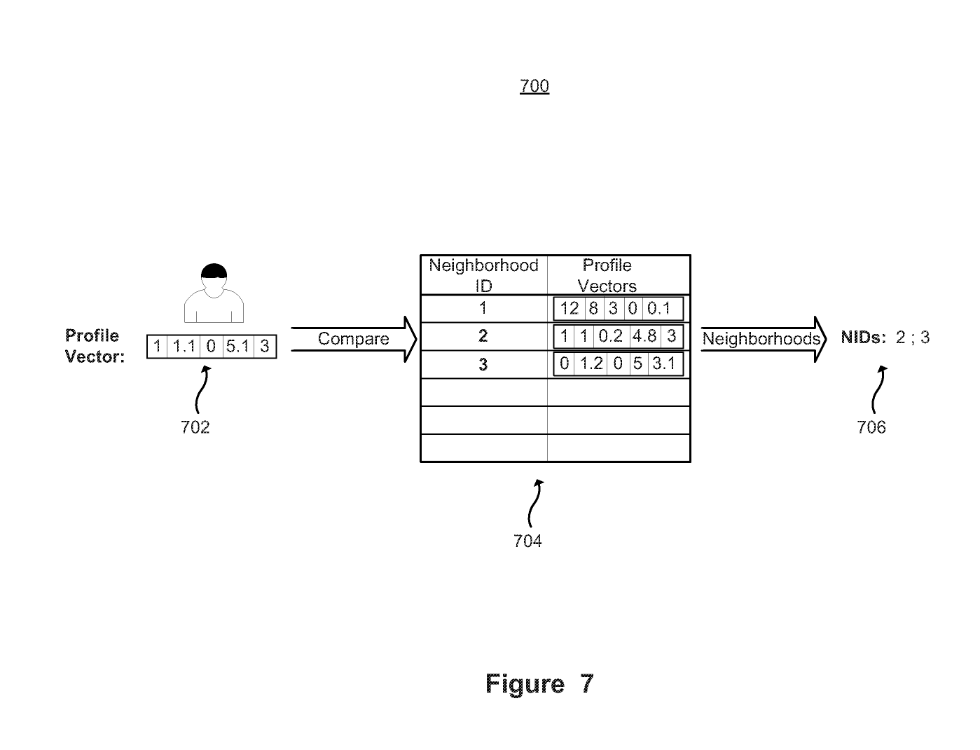

FIG. 7 depicts a further process for selecting potential neighborhoods for a user profile. The process 700 assumes that the profiles comprise demographic profile vectors instead of classification identifiers as described above with regard to FIG. 6. As depicted the profiles comprise a five element vector. It is noted that the neighborhood profile table 704 depicts a single profile vector associated with each of the neighborhoods; however it is contemplated that each of the neighborhoods may be associated with a plurality of profile vectors.

When comparing profile vectors to determine a match, it is possible for two vectors to be considered a match even though the vectors are not identical. The comparison between two vectors may be based on a distance between the two vectors. If the distance between the two vectors is less than a threshold value, the two vectors may be considered a match. When a neighborhood profile matches a user profile, the associated neighborhood may be added to a list of potentially appropriate neighborhoods 706.

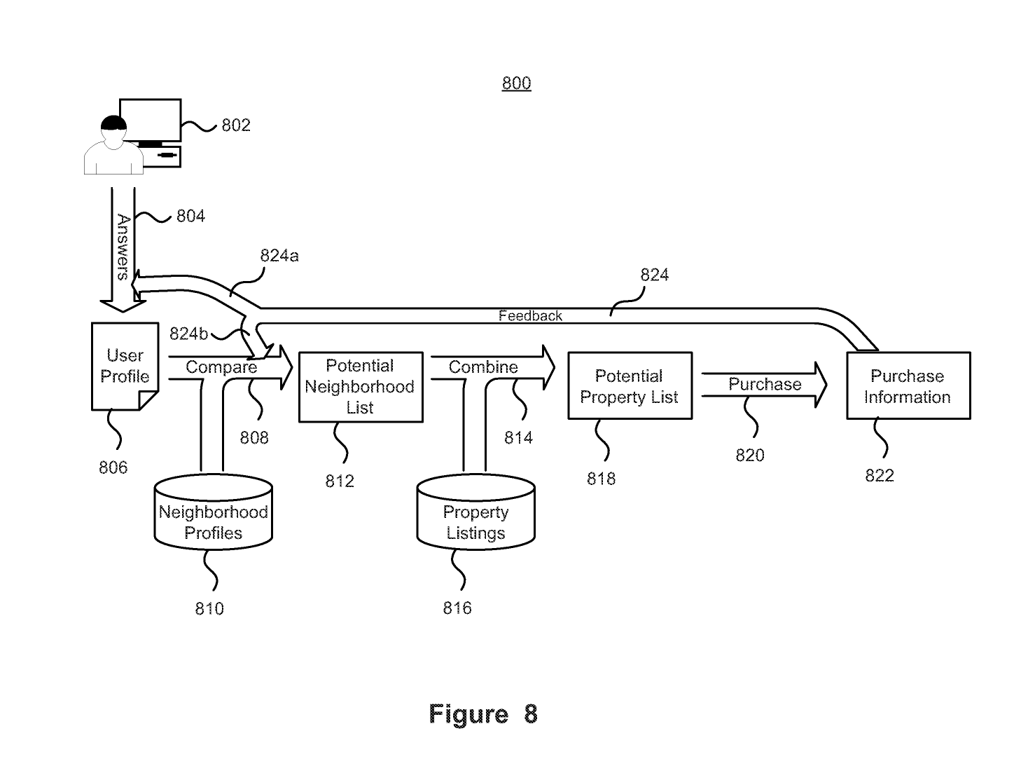

FIG. 8 depicts a further process for selecting potential neighborhoods for a user. The process 800 begins with a user utilizing a computing device 802 to provide answers 804 to a plurality of questions which are processed to provide a user profile 806. The user profile is compared 808 to neighborhood profiles 810 to generate a potential neighborhood list 812. The neighborhood list 812 may be combined 814 with property listing information 816 to provide a list of potential properties 818. The user may purchase a home 820, which may be located in one of the identified neighborhoods. The purchase information 822 is used in a feedback process 824. The feedback may be used to verify and/or adjust the profile generation and/or comparison process based on the purchase information. For example, if the user purchases a home from a neighborhood identified as an appropriate neighborhood, the feedback can be used to verify the assumptions used to generate the user profile and compare it to neighborhood profiles. However, if the user purchased a home in a neighborhood not identified, the feedback may adjust the process for generating and comparing the profiles so that the neighborhood the user purchased in would have been identified.

Although the above described using a house purchase as feedback, it is contemplated that other actions or information may be used as feedback. For example, a user contacts a real-estate agent associated with an identified neighborhood may be viewed as feedback indicative that the identified neighborhood was a good, or at least acceptable, match. Similarly, an offer to purchase a property, regardless of if it is completed may be used as feedback. Further feedback may include information provided by the user themselves. For example, the user may provide feedback through the website interface indicating that the suggested neighborhoods were appropriate; however, the user is no longer moving.

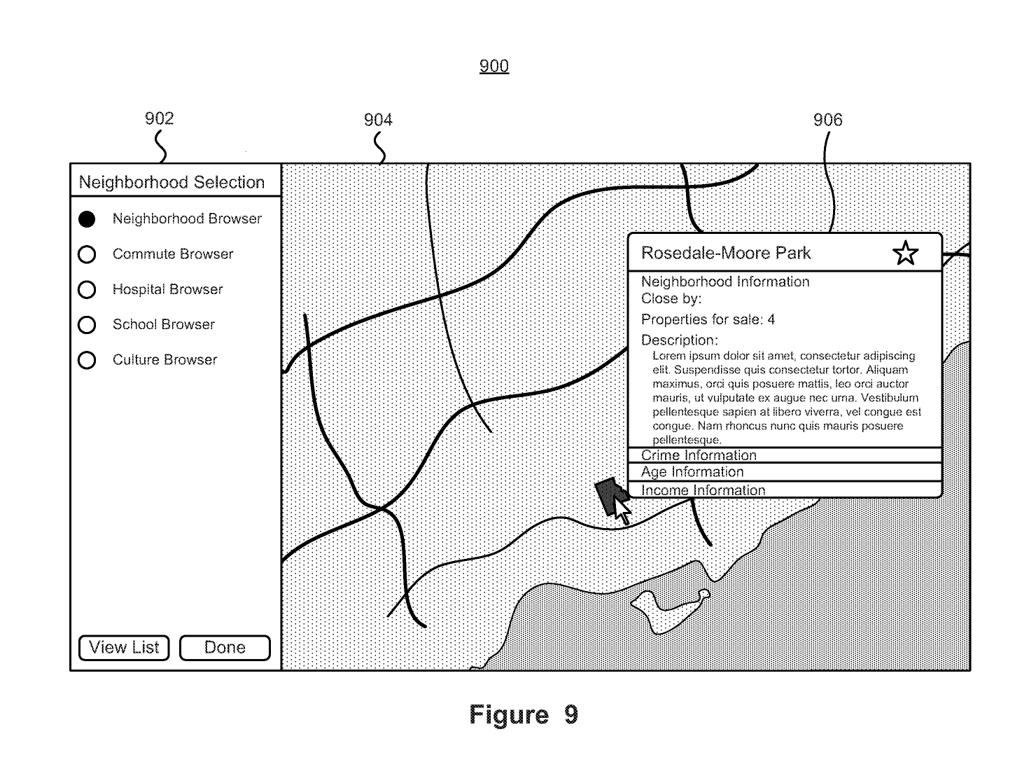

FIGS. 9-11 depict user interfaces for selecting potential neighborhoods for a user. The user interfaces depicted in FIGS. 9-11 are illustrative only, and various different interfaces may be provided. The user interface 900 depicts a screen that may be provided by the neighborhood selection computing device and displayed on the user's computing device. The user interface 900 may provide an interface for selecting a plurality of neighborhoods. The interface may provide a number of different ways to select neighborhoods, in addition to answering a plurality of demographic questions. The interface 900 may include a panel 902 for selecting one of a plurality of ways of selecting neighborhoods. As depicted in FIG. 9, a neighborhood browser may allow a user to browse information of different neighborhoods displayed on a map panel 904. For example, a user may hover over a map, and the interface may display neighborhood information 906 including for example, a name of a neighborhood, a description of the neighborhood, as well as neighborhood information such as crime information, age information, and income information. The neighborhood information may include an option for adding the neighborhood to a potential neighborhood list. For example, the neighborhood information may include a favorite icon, such as a star, that allows the neighborhood to be added the potential neighborhood list.

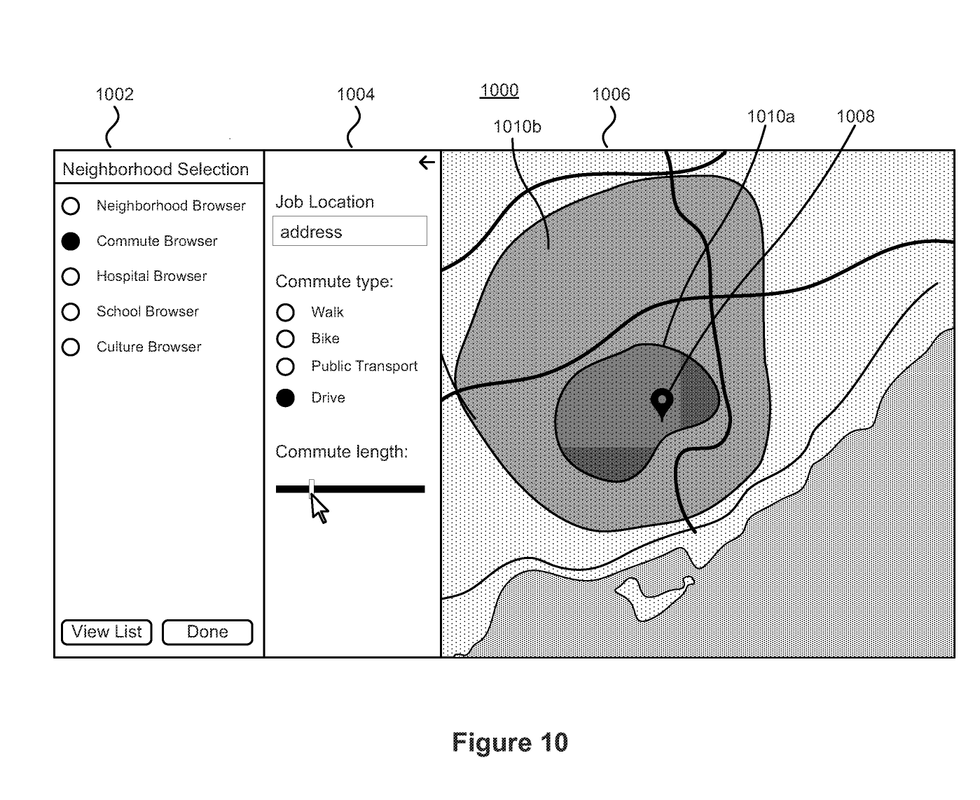

FIG. 10 depicts a further interface screen 1000 for selecting potential neighborhoods. The screen 1000 depicted in FIG. 10 allows a user to select, filter or rank, potential neighborhoods based on a desired commute length. The screen 1000 comprises a neighborhood selection panel 1002 that allows the different neighborhood selection options to be selected. A commute panel 1004 allows the user to specify a job location as well as a commute type, such as waling, driving, taking public transport, etc. and a desired length of the commute. A map panel 1006 may indicate a location of the specified job 1008 as well as a heat map, depicted as shaded areas 1010a, 1010b, indicative of a length of time of the commute to particular locations. The commute length of neighborhoods may be used to filter, rank or weight neighborhoods on a potential list of neighborhoods, or neighborhoods may be added to the list from the map panel 1006.

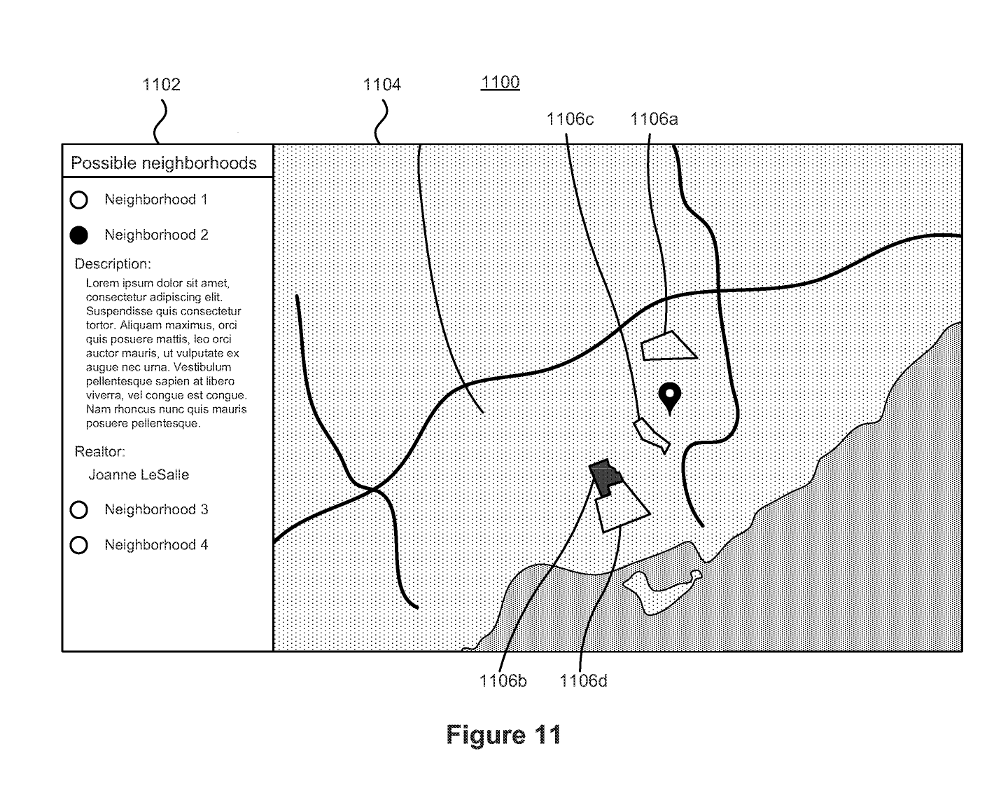

FIG. 11 depicts a screen 1100 for reviewing neighborhoods on a list of potential neighborhoods. The screen 1100 may include a neighborhood list panel 1102 that provide a list of potential neighborhoods and possibly additional neighborhood information, such as a description of the neighborhood. Additionally, a map panel 1104 may provide an outline of neighborhoods 1106a, 1106b, 1106c, 1106d on the neighborhood list. The screen 1100 may allow a user to browse neighborhoods on the list and illuminate one or more neighborhoods from the potential neighborhood list.

Although not depicted, the user's actions while interacting with the user interface may be tracked and analyzed in order to determine potential implicit indications of a user's preference for neighborhoods. For example, if a user spends a considerable amount of time investigating three neighborhoods, it is possible to identify common characteristics of the three neighborhoods and assume that these characteristics are important to the user. This implicit information may be used in determining appropriate neighborhoods. For example, the implicit information may be used to add, remove, filter or order neighborhoods.

As described above, by profiling neighborhoods, as well as users, it is possible to generate a list of one or more potential neighborhoods that may be appropriate for the user. The identified neighborhoods may be used in searching for a home or property for the user. Although the above has described the neighborhood selection as being done in relation to purchasing a home, it may be used for rental properties as well as other purposes in which a list of one or more neighborhoods associated with a user may be beneficial.

The system described above may provide a web based decision support platform designed for residential home buyers. The system may determine lifestyle preferences of the individual and then match the determined preferences to city neighbourhoods and communities. Using the described system, a home buyer may readily access an extensive array of city data related to property assessments, school districts, schools, age of houses, zoning applications, crime, demographics, ethnicity, health, commute times, hospitals, environment and more.

The system may be built as a platform solution that enables delivery of third party products/services and advertising to residential home buyers. For example, home buyers may use the described system to access third party details such as a ‘door score’ of each residential home in one or more neighborhood. The ‘door score’ may be a third party metric comprised of the ranking of that home against a city-wide or neighbourhood-wide average on the basis of property risk, area crime, area education statistics and other factors. Using the described system, a prospective home owner may purchase and download reports, which may be provided directly or through third parties, on each of these factors. Additionally, or alternatively, the functionality described

Each element in the embodiments of the present disclosure may be implemented as hardware, software/program, or any combination thereof. Software codes, either in its entirety or a part thereof, may be stored in a computer readable medium or memory, including for example a ROM providing a non-volatile memory such as flash memory, CD ROM, DVD ROM, Blu-ray™, a semiconductor ROM, USB, or a magnetic recording medium, for example a hard disk. The program may be in the form of source code, object code, a code intermediate source and object code such as partially compiled form, or in any other form.

It would be appreciated by one of ordinary skill in the art that the system and components shown in Figures may include additional or alternative components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

What is claimed is:

1. A method for identifying an appropriate neighborhood for a user comprising:
receiving answers to a plurality of profiling questions at a computing system;
generating at the computing system a user profile of the user based on the received answers to the plurality of profiling questions;
comparing at the computing system the user profile to a plurality of neighborhood profiles, each generated according to classification information of a respective physical neighborhood associated with the respective neighborhood profile; and
identifying at the computing system at least one of the plurality of neighborhood profiles as appropriate for the user based on results of the comparison between the user profile and neighborhood profiles.

2. The method of claim 1, further comprising generating and storing the plurality of neighborhood profiles for a city.

3. The method of claim 2, wherein generating each of the plurality of neighborhood profiles comprises:
selecting one or more profile identifiers from a plurality of predefined profile identifiers based on the classification information of the respective physical neighborhood.

4. The method of claim 3, wherein generating the user profile comprises:
mapping the received answers to the plurality of profiling questions to at least one of the plurality of predefined profiles identifiers.

5. The method of claim 3, further comprising:
adjusting the mapping between received answers and the at least one of the plurality of predefined profile identifiers based on user feedback.

6. The method of claim 5, wherein the user feedback comprises one or more of:
enlisting a real-estate agent associated with a particular neighborhood;
purchasing a piece of property in a particular neighborhood; and
reviewing property for sale in a particular neighborhood.

7. The method of claim 2, wherein generating each of the plurality of neighborhood profiles comprises:
generating a profile vector comprising a plurality of classification values associated with classification vector characteristics arranged in a predefined order.

8. The method of claim 7, wherein generating the user profile comprises:
determining a plurality classification values associated with the classification vector characteristics based on the received answers to the plurality of profiling questions;
generating a user profile vector comprising the plurality of classification values associated with classification characteristics arranged in the predefined order.

9. The method of claim 2, wherein one or more of the plurality of neighborhood profiles is based on one or more of:
demographic information;
cultural information;
proximity information;
education information;
health related information;
environment related information; and
recreational information.

10. The method of claim 1, wherein the classification information of the physical neighborhoods is provided from one or more of:
questionnaire information;
survey information;
census information;
consumer information; and
feedback information.

11. The method of claim 1, where the plurality of neighborhood profiles are further generated based on information of one or more of:
numbers and types of businesses in the respective neighborhood;
number of hospitals in the respective neighborhood; and
number of schools in the respective neighborhood.

12. The method of claim 1, wherein comparing the user profile to the plurality of neighborhood profiles comprises:
determining if an identifier associated with the user profile corresponds to an identifier associated with a neighborhood profile; and
adding the neighborhood profile to a list of potential neighborhoods when the identifiers correspond to each other.

13. The method of claim 12, wherein identifying at least one of the plurality of neighborhood profiles as appropriate for the user comprises:
selecting one or more of the at least one neighborhoods on the list of potential neighborhoods.

14. The method of 12, further comprising:
adding one or more neighborhoods to the list of potential neighborhoods.

15. The method of claim 14, wherein the one or more neighborhoods are added to the list of potential neighborhoods based on an implicit or explicit interest in the neighborhood expressed by the user.

16. The method of claim 15, wherein implicit interest in a neighborhood is determined by:
tracking user interactions with a displayed neighborhood map;
tracking internet browsing of the user;
using a wizard to determine neighborhoods within a specified distance of a location; and
using a wizard to determine neighborhoods having a specified characteristic.

17. The method of claim 15, wherein explicit interest in a neighborhood is determined by a user performing an action to add a specified neighborhood to the list of potential neighborhoods.

18. The method of claim 12, wherein the list of potential neighborhoods is ordered based on a determined appropriateness for the user.

19. The method of claim 18, further comprising:
adjusting an ordering of the list of potential neighborhoods based on one or more weighting factors.

20. A system for identifying an appropriate neighborhood for a user comprising:
a processing unit for executing instructions; and
a memory unit for storing instructions which when executed by the processing unit configure the system to:
receive answers to a plurality of profiling questions at a computing system;
generate at the computing system a user profile of the user based on the received answers to the plurality of profiling questions;
compare at the computing system the user profile to a plurality of neighborhood profiles, each generated according to classification information of a respective physical neighborhood associated with the respective neighborhood profile; and
identify at the computing system at least one of the plurality of neighborhood profiles as appropriate for the user based on results of the comparison between the user profile and neighborhood profiles.
